(19) United States
(12) Patent Application Publication
(10) Pub. No.: US 2022/0277874 A1
(43) Pub. Date: Sep. 1, 2022

(54) DEVICE FOR GENERATING PROPULSION FORCE BY USING A SUPERCONDUCTIVE SOLENOID

(71) Applicant: Athanassios A NASSIKAS, Larissa (GR)

(72) Inventor: Athanassios A NASSIKAS, Larissa (GR)

(21) Appl. No.: 17/637,460

(22) PCT Filed: Aug. 26, 2020
(86) PCT No.: PCT/GR2020/000040

§ 371 Date: Feb. 23, 2022

(30) Foreign Application Priority Data
Aug. 28, 2019 (GR) 20190100373

(51) Int. Cl. H01F 6/06; H01F 6/04

(52) U.S. Cl. CPC H01F 6/06; H01F 6/04

(57) ABSTRACT

Device (1) for generating propulsive force F consisting of an electrically-supplied superconductive solenoid (2) generating magnetic flux ϕ with density B, a superconductive magnetic-field shield (5) covering the solenoid (2), means (4) for cooling the solenoid (2) and the shield (5) and a core of high magnetic permeability (3) around which the solenoid (2) is wound generating magnetic flux density vectors B_{α} and B_{β} at the respective ends (α, β) of the core (3). The core (3) includes one or more curved parts so that when the solenoid (2) operates, the vectors B_{α}, B_{β} tend to be perpendicular to the respective cross-sections of the ends (α,β), and the alteration of direction of the vector B along each curved part generates force vectors F_{α}, F_{β} acting perpendicularly to the cross-sections of the ends (α, β), the sum of F_{α} and F_{β} generates the force F in the device (1).

### TECHNICAL FIELD

The present invention relates to a device for generating propulsive force, and in particular a device for generating propulsive force by using a superconductive solenoid.

### BACKGROUND

The technology on which the present invention is based is the technology of the high-magnetic-field superconductive magnets and of the superconductive solenoids. This technology is widely known to the relevant institutes such as NHMFL (National High Magnetic Field Laboratory) in USA, and the HMFL (High Magnetic Field Laboratory) of the Chinese Academy of Sciences, as well as to manufacturers such as Bruker Co, Oxford Instruments and High Field Magnets SuperPower Inc., while relevant articles are published in journals such as “IEEE Transactions on Applied Superconductivity”.

The generation of propulsive force by using a magnetic field is known in the prior art through inventions and developed technologies, e.g.:
1. H. Johnson, 1995. “Magnetic Propulsion System”, USA patent application no. U.S. Pat. No. 5,402,021 A.
2. M. Brady, 2006. “Permanent Magnet Machine (Perendev)”. PCT patent application no WO2006/045333 A1.
3. Kambe, Yoshitaka, TOYOTA MOTOR CO LTD (JP), 1996. “Superconductor motor”. European Patent Application EP0748033A2.
4. P. S. Swartz, 1968. “Superconductive Shield”, USA Patent application no. U.S. Pat. No. 3,378,691 A.
5. Nassikas Athanassios A., 2015. “Magnetic propulsion device using superconductors” USA patent no U.S. Pat. No. 8,952,773 B2.
6. Nassikas Athanassios A., 2013 “Apparatus for generating a propulsive force using superconductors”, PCT patent application no. WO2013/110960 A1.
7. Nassikas Athanassios A., 2016. “Mechanism creating propulsive force by means of a conical coated tape superconducting coil”, PCT patent application no. WO2016/142721 A1.
8. The technology of the superconductive MAGLEV magnetic levitation trains.

From the prior technologies, the 1^{st}, 2^{nd}, 3^{rd}, 4^{rd}, and 8^{th} are based on magnetic interaction between adjacent elements, whereas the 6^{th} and 7^{th} technologies generate propulsive force, however they are based on the 5^{th} technology, i.e. the technology disclosed in U.S. Pat. No. 8,952,773 B2, which has been experimentally confirmed.

In particular, U.S. Pat. No. 8,952,773 B2 regarding the technology closest to the present invention disclosed a device for generating propulsive force. This device comprises a superconductive magnetic-field shield which has the form of a convergent nozzle that has at the one end a larger opening and at the other end a smaller opening. Furthermore, the specific device includes a magnetic-field source which according to an embodiment may be superconductive solenoid, and which is fixed at its end to the smaller opening of the superconductive magnetic-field shield. Also, the said device includes means for cooling the superconductive magnetic-field shield to below than a critical temperature (Tc) for the maintenance of the superconductive properties of the superconductive magnetic-field shield. The magnetic field of the magnetic-field source applies pressure on the inner surface of the superconductive magnetic-field shield, where this pressure produces a propulsive force on the said device towards the convergence of the nozzle. This propulsive force may be used in the propulsive thrust required in any machine or vehicle, as well as in the production of energy.

However, one of the disadvantages of this device is the failure to generate a strong propulsive force. Another disadvantage is the susceptibility of the device to external fields such as the earth's magnetic field, resulting to the generation of propulsive force exclusively in the South-North direction of the earth's magnetic field. As a result, the device cannot generate propulsive force in a direction opposite to the direction of gravity.

### SUMMARY OF THE INVENTION

In order to overcome one or more of the above-mentioned disadvantages, the device for generating propulsive force F according to the invention, as claimed in the main claim 1, comprises:
a superconductive solenoid having means for supplying electric energy for the generation of magnetic flux ϕ with magnetic flux density B,
a superconductive magnetic-field shield covering the superconductive solenoid, which prevents the magnetic field from passing through,
cooling means that cool the superconductive solenoid and the superconductive magnetic-field shield to a temperature lower than a critical temperature T_{c}, for maintaining the superconductive properties of the superconductive solenoid and the superconductive magnetic-field shield,

and characterized in that it further comprises:
a core of a high magnetic permeability having ends (α) and (β), wherein the superconductive solenoid is wound at least in part around the high-magnetic-permeability core so that a magnetic flux density B is generated throughout the high-magnetic-permeability core from the one end (a) to the other end (D) with respective magnetic flux density vectors B_{α} and B_{β} at the ends (α) and (β), and in that the superconductive magnetic-field shield covers the superconductive solenoid and extends over the length of the high-magnetic-permeability core from the one end (α) to the other end (β), wherein the high-magnetic-permeability core includes one or more curved parts of any curvature so that when the superconductive solenoid operates the B_{α} and B_{β} vectors of the magnetic flux density tend to be perpendicular to the respective cross-sections of the ends (α) and (β), so that the alteration of the direction of the magnetic flux density B produced along each curved part generates force vectors F_{α} and F_{β} at the respective ends (α) and (β) which extend perpendicularly to the cross-sections of the ends (α) and (β) with direction outwards in respect to the high-magnetic-permeability core and which generate a propulsive force F on the device with direction and magnitude produced from the sum of the force vectors F_{α} and F_{β}.

Further embodiments of the device that define specific operational parameters are presented in the dependent claims 2-9.

### BRIEF DESCRIPTION OF THE DRAWINGS

The present invention will be fully understood by those skilled in the art through the exemplary embodiments depicted in the accompanying figures, wherein the details of the fixation the various parts are not shown but may be effected according to the existing art.

FIG. 1 is a cross-section of the device for generating propulsive force according to an embodiment of the invention.

FIG. 2 is a cross-section of the device for generating propulsive force according to another embodiment of the invention.

FIG. 3 is a cross-section of the device for generating propulsive force according to another embodiment of the invention.

### PRINCIPLE OF OPERATION

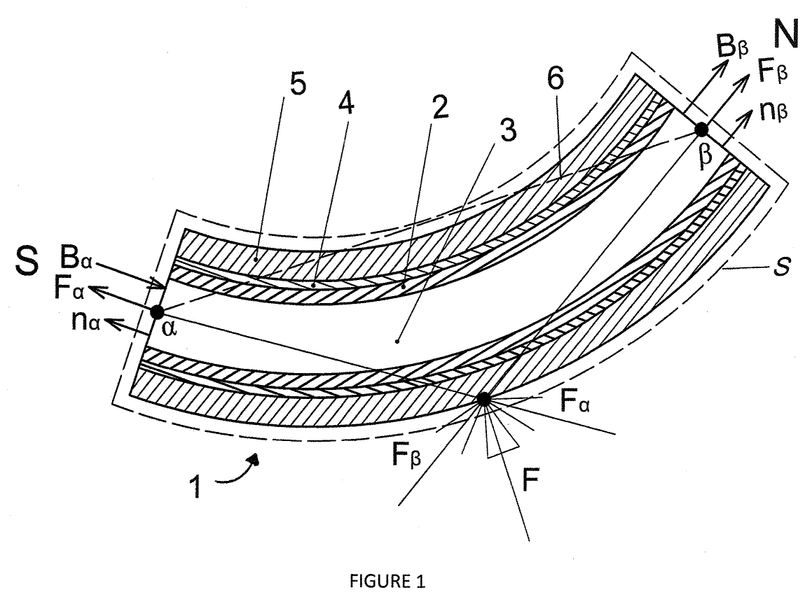

Based on the classical theory of magnetic fields (Quick Field, Finite Element Systems, User's Guide Version 5.3—Tera Analysis Ltd—2005), it is known that a force acting on a closed surface S, e.g the surface enclosing the device of the present invention as shown in FIG. 1 is:

$$F = \frac{1}{2} {∯}_{S} [ H ( n \cdot B ) + B ( n \cdot H ) - n ( H \cdot B ) ] ds \qquad ( 1 )$$

Wherein H is the intensity of the magnetic field, B is the density of the magnetic flux and n is the vector perpendicular to the surface S and directed outwards.

From the equation (1), the force dF acting on a surface dS perpendicular to the Intensity H of the magnetic field is derived, and given that

n·B=B and n·H=H or n·B=−B and n·H=−H
the force dF is equal to:

$$dF = \frac{1}{2} n ( H \cdot B ) dS = n \frac{{B}^{2}}{2 {μ}_{0}} d S \qquad ( 2 )$$

where μ₀ is the magnetic permeability in vacuum.

From the equation (2) it is concluded that the vectors of the forces F_{α} and F_{β} acting on the cross-sections of the ends (α) and (β) of the high-magnetic-permeability core of the device of the invention described hereinbelow have the same direction to the respective vectors n_{α} and n_{β} which are perpendicular to the cross-sections of the ends (α) and (β) respectively with direction towards the exterior of the high-magnetic-permeability core as shown in FIGS. 1, 2 and 3.

Based on the equations (1) and (2) and with reference to the FIGS. 1, 2 and 3, for a surface S enclosing the device of the present invention,

$$F = {F}_{α} + {F}_{β} = \frac{{n}_{α}}{2 {μ}_{0}} {A}_{α} {B}_{α}^{2} + \frac{{n}_{β}}{2 {μ}_{0}} {A}_{β} {B}_{β}^{2} \qquad ( 3 )$$

wherein (α) and (β) are the ends of the high-magnetic-permeability core, A_{α} is the cross-section area of the end (α), A_{β} is the cross-section area of the end (β), B_{α} is the magnetic flux density at the end (α) and B_{β} is the magnetic flux density at the end (β).

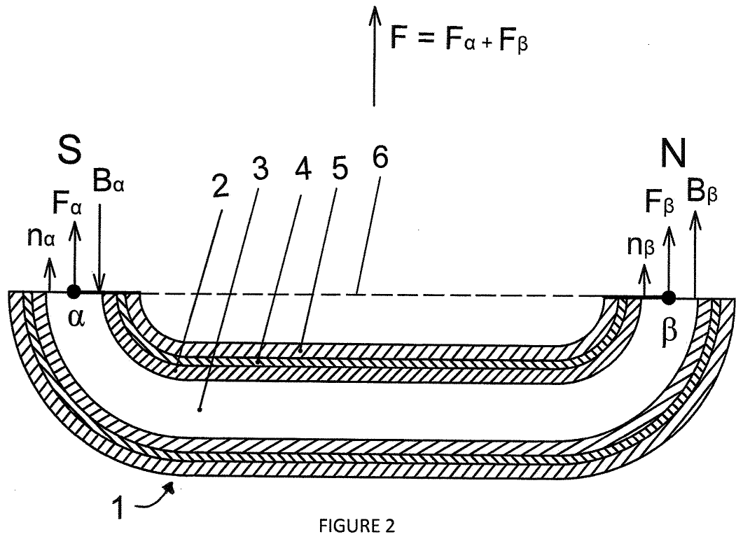

In particular, in the device of FIG. 2 for:

A_{α}=A_{β}, n_{α}=n_{β}
and based on the preservation of the magnetic flux ϕ (due to the presence of a superconductive magnetic-field shield, which covers the superconductive solenoid and prevents the magnetic field from passing through as mentioned hereinbelow):

$$F = {F}_{α} + {F}_{β} = \frac{{n}_{α}}{{μ}_{0}} {A}_{α} {B}_{α}^{2} \qquad ( 4 )$$

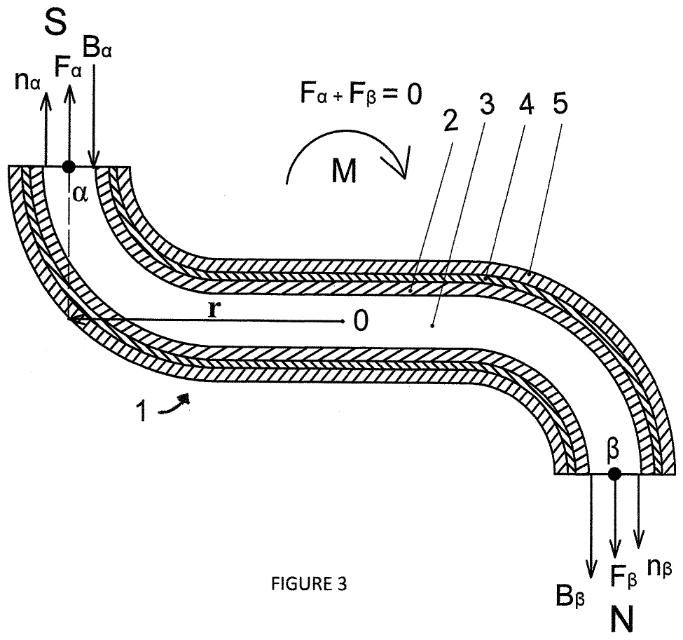

In the device of FIG. 3 for:

A_{α}=A_{β}, n_{α}=−n_{β}
and based on the preservation of the magnetic flux ϕ (due to the presence of the superconductive magnetic-field shield):

$$\begin{matrix}F = {F}_{α} + {F}_{β} = 0 & ( 5 ) \\ M = 2 r \times {F}_{α} = \frac{{n}_{α} \times r}{{μ}_{0}} {A}_{α} {B}_{α}^{2} & ( 6 ) \\ M = \frac{1}{{μ}_{0}} {A}_{α} {B}_{α}^{2} r & ( 7 )\end{matrix}$$

Wherein r is the vector of the perpendicular distance of the vector F_{α} from the turning center O, and M is the vector of the developed torque.

The precise value of the force, due to the equation (4) is a function of the magnetic flux density B_{α} which can be derived by finite element analysis as well as experimentally for better coincidence between theory and result.

It should be noted that as regards the superconductors, there isn't any single type of equations over all their range and any deviation from the principles of classical physics must be understood within this framework.

Furthermore, it is noted that the single field principle has not been formulated as a unified accepted theory, and for the needs of the present invention it is approached by the theory developed in the following studies:
“Nassikas, A. A. 2008, Minimum Contradictions Everything, reviewed and edited by Duffy, M. C. and Whitney, C. K. ISBN: 1-57485-061-X, Hadronic Press, pages 185.”
“A. A. Nassikas, 2010. Minimum Contradictions Physics and Propulsion via Superconducting Magnetic Field Trapping SPESIF, AIP Conf. proc. 1208, pp. 339-349.”.

According to these studies, the stochastic quantum space-time constitutes the matter itself, which can facilitate the interpretation of the deviation from classical physics. In particular, the electromagnetic field behaves as a material gravity field with imaginary (i) mass. The exchange of energy and momentum between the gravity field and the electromagnetic field is performed via photons which are the only that can be transformed to particles-space-time formations of the one field to particles-space-time formations of the other. In a first approach this seems to result from the equations:

E²=c²P²,(iE)²=c²(iP)² (8)

which associate the energy and the momentum of a photon according to the relativistic quantum mechanics and apply both for real space (gravitational space-time) and for the imaginary space (i-electromagnetic space-time).

From the magnetostatic analysis and the mechanics of the incompressible fluid:

Δψ=0, Vψ=B, Aφ=0, Δφ=V (9)

Wherein ψ and ϕ are the functions of the magnetic and fluid-mechanical potential and B and V are the vectors of the magnetic flux density in the fluid magnetostatics and of the fluid velocity in the fluid mechanics respectively.

From the equations (9) it is derived that the magnetostatic field is similar to the fluid-mechanics field where the vector of the magnetic flux density B behaves as the velocity vector V.

From the equation (4) and the respective fluid-mechanics equation for a similar device:

$$\begin{matrix}F = \frac{n}{{μ}_{0}} {AB}^{2} & ( 10 ) \\ F = - n 2 ρ {AV}^{2} & ( 11 )\end{matrix}$$

wherein ρ is the density of the fluid with which the simulation is effected. From the equations (10) and (11):

B=±i\sqrt{2μ₀ρ}V (12)

The equation (12) shows that the magnitude B cannot be simulated by something real (mechanical-gravitational) but by an imaginary magnitude which refers to the electromagnetic space such as the equations (8).
It is noted that in an experiment performed to confirm the said U.S. Pat. No. 8,952,773, it was observed that the developed force is opposite to the expected one in a hydrodynamically similar device, which is compatible with the equations (10), (11) and (12) that regard the present invention.

The experiment was performed both in the Thessaly Technological Institute (now University of Thessaly), in the Renewable-Energy-Form Laboratory and in the Solid-State-Physics Laboratory of the University of Athens.

### DETAILED DESCRIPTION OF THE PREFERRED EMBODIMENTS

FIG. 1 shows an embodiment of the device for generating propulsive force F which includes a superconductive solenoid (2) equipped with energy supply means for the generation of the magnetic flux ϕ with magnetic flux density B, a superconductive magnetic-field shield (5) which covers the superconductive solenoid (2) and blocks the penetration of the magnetic field, and cooling means (4) which cool the superconductive solenoid (2) and the superconductive magnetic-field shield (5) to below a critical temperature T_{c} for the preservation of the superconductive properties of the superconductive solenoid (2) and the superconductive magnetic-field shield (5).

The said energy supply means are not shown in the figures. The energy supply means provide the electric power required for the operation of the superconductive solenoid (2) at least at the start or when the current intensity of the superconductive solenoid (2) has to be changed.

The superconductive solenoid (2) and the superconductive magnetic-field shield (5) must be below the critical temperature T_{c} when the magnetic field intensity is equal or smaller than a critical value H_{c} in order to operate smoothly and keep their superconductive properties. The specific critical temperature T_{C} depends on the superconductive material of the superconductive solenoid (2) and the superconductive magnetic-field shield (5).
According to an embodiment, the superconductive solenoid is a type 11 superconductor, e.g. an activated tape or wire of the ReBCO or YBCO or Bi2223 or Nb/Ti type, wound at least in part around the high-magnetic-permeability core (3). Type II superconductors are mainly used, including those mentioned above, given that the type I superconductors lose their properties when the magnetic field becomes strong.

Also, according to an embodiment, the high magnetic permeability core (3) is a soft iron core. The term “high” magnetic permeability means a magnetic permeability much higher than that of vacuum, for example 1000 times higher than that of vacuum.

Furthermore, according to an embodiment, the cooling means (4) is a precooled copper wire arranged between the superconductive solenoid (2) and the superconductive magnetic-field shield (5) and wound around the superconductive solenoid (2).

The precooled copper wire is precooled in an heat exchanger by liquid He or liquid N and cools by conduction the superconductive solenoid (2) and the superconductive magnetic field shield (5).

Alternatively, the cooling of the superconductive solenoid (2) and the superconductive magnetic-field shield (5) may be effected by immersion of the whole device (1) in a vessel containing liquid He or liquid B. In this case, no precooled copper wire is used.

Also, according to an embodiment, the superconductive magnetic field shield (5) comprises along its length a YBCO bulk and/or a Bi2223 magnetic shield cover and/or a REBCO tape winding.

Also, the embodiment of the device for generating a propulsive force F of FIG. 1 includes a high magnetic permeability core (3) of a constant cross-section with ends (α) and (β), wherein the superconductive solenoid (2) is wound at least in part around the high magnetic permeability core (3) so that a magnetic flux density B over the high magnetic permeability core (3) from the one end (α) to the other end (β), with respective magnetic flux density vectors B_{α} and B_{β} at the ends (α) and (β).

According to an embodiment, the high magnetic permeability core (3) is a soft-iron core. Also, as shown in the embodiment of the device for generating a propulsive force F of FIG. 1, the superconductive magnetic field shield (5) covers the superconductive solenoid (2) and extends along the length of the high magnetic permeability core (3) from the one end (α) to the other end (β). Also, the high magnetic permeability core (3) is curved along its length, so that when the superconductive solenoid (2) is in operation, the vectors B_{α} and B_{β} of the magnetic flux density tend to be perpendicular to the respective cross-sections of the ends (α) and (β), so that the variation of the direction of the magnetic flux density B along the length of the curved high magnetic permeability core (3) generates the force vectors F_{α} and F_{β} at the respective ends (α) and (β), which act perpendicular to the cross-sections of the ends (α) and (β) with a direction outwards from the high magnetic permeability core (3). The force vectors F_{α} and F_{β} generate a propulsive force F on the device
(1) with a direction and magnitude derived from the sum of the force vectors Fα and FP.

FIGS. 2 and 3 show two alternative embodiments of the device for generating a propulsive force F which deviate from the embodiment of Figure (1) in that the high magnetic permeability core (3) includes an elongate part that ends to a curved part at each of the ends (α) and (β) of the high magnetic permeability core (3).

According to FIG. 2, the curved part at the end (α) of the high magnetic permeability core (3) is configured with a direction same as the curved part at the end (β) of the high magnetic permeability core (3). As a result of that, the propulsive force F is equivalent to the sum of the force vectors F_{α} and F_{β} of the same direction at the ends (α) and (β) respectively of the high magnetic permeability core (3), as shown in FIG. 2.

In contrast, the curved part at the end (α) of the high magnetic permeability core (3) is configured with a direction opposite to that of the curved part at the end (β) of the high magnetic permeability core (3). As a result of that, the generation of torque M derived from the opposite directions of the forces F_{α} and F_{β} at the ends (α) and (β) respectively of the high magnetic permeability core (3), as shown in FIG. 3.

Apart from the exemplary embodiments described in FIGS. 2 and 3, the high magnetic permeability core (3) may include various combinations of curves and linear parts not shown in the figures. Also, in the exemplary embodiments of the FIGS. 1, 2, and 3, the high magnetic permeability core (3) has a constant cross-section along its length. However, according another embodiment, the high magnetic permeability core (3) may have a varying cross-section along its length e.g. it may be a convergent high magnetic permeability core.

After finite element analysis for the comparison of the device of the prior art described in the said U.S. Pat. No. 8,952,773B2 with the device of the present invention, it was concluded that the propulsive force generated by the device of the present invention is much more significant than that of the device of U.S. Pat. No. 8,952,773. Experimentally, it was also observed that the propulsive force of the said device of the prior art has exclusively the North-South direction of the earth's magnetic field. The device of the present invention may generate a propulsive force at any direction perpendicular to the North-South direction of the earth's magnetic field, and for example may generate propulsive force with a direction opposite to gravity. This is due to the structure of the device of the invention which is such that when the superconductive solenoid (2) is in operation, the vectors B_{α} and B_{β} of the magnetic flux density tend to be perpendicular to the respective cross-sections of the ends (α) and (β), so that the resulting variation of the direction of the magnetic flux density B generates force vectors F_{α} and F_{β} at the respective ends (α) and (β), which act perpendicularly to the cross-sections of the ends (α) and (β) with a direction outwards from the high magnetic permeability core (3) and which generate a propulsive force F on the device (1) with a direction and magnitude derived from the sum of the forces F_{α} and F_{β}.

Due to the direction of the vectors B_{α} and B_{β}, which tend to be perpendicular to the respective cross-sections of the ends (α) and (β) of the high magnetic permeability core (3), the regions of the ends (α) and (β) of the high magnetic permeability core (3) constitute the poles S and N of the device (1) of the invention, and thus the axis (6) connecting the ends (α) and (β) of the high magnetic permeability core (3) is parallel to the intensity of the earth's magnetic field at the location of the device (1). The device (1) (FIG. 2) rotating around the axis (6) connecting the ends (α) and (β) may generate propulsion to all directions perpendicular to the axis, however not on the direction of the axis it self as effected by the device of the prior art described in U.S. Pat. No. 8,952,773 B2. In this way, the device (1) of the present invention may operate in combination with the device disclosed in U.S. Pat. No. 8,952,773, so that propulsive force F is generated in all the desired directions.

In particular, in the device of FIG. 2, due to the equation (4), the force F will be opposite to gravity. On the elongate part of the device (1) of FIG. 2, the combination of the superconductive solenoid (2) and the high magnetic permeability core (3) operates as a magnet which could also be used to increase the propulsive capacity of the device of U.S. Pat. No. 8,952,773 B2.

Furthermore, the device (1) of FIG. 3, due to the torque M it produces, can be used in the rotation of the device (1) and thus in the production of energy.

By increasing the distance between the ends (α) and (β) of the high magnetic permeability core (3) and the thickness of the superconductive solenoid (2), the magnetic flux density, the ampere-turns generated by the superconductive solenoid (2) and the propulsive force created are increased.

The present invention is not limited to the exemplary superconductive materials and cooling means mentioned but may be applied with any superconductive material and cooling means known and suitable for the requirements of the invention.

A permanent magnet may be used instead of the combination of a superconductive solenoid (2) and a high magnetic permeability core (3). Also, graphene may be used instead of ReBCo or Bi2223 or YBCO bulk in the superconductive magnetic-field shield (5). Advantage of the graphene is that it largely prevents the magnetic field from passing through the superconductive magnetic-field shield (5) at much higher temperatures than those required for REBCO or Bi2223 or YBCO bulk and thus the use of cooling means as those used in the device (1) of the invention are not necessary. However, the use of a permanent magnet and graphene will likely not produce significant propulsive force F.

Because of equation (3) the propulsive force F created is invariant to the magnetic field direction; therefore the device (1) can operate with DC and AC energy source as well. The use of AC energy source eliminates the influence of any external magnetic field.

1. Device (1) for generating propulsive force F comprising:
a superconductive solenoid (2) having means for supplying electric energy for the generation of magnetic flux ϕ with magnetic flux density B,
a superconductive magnetic-field shield (5) covering the superconductive solenoid (2), which prevents the magnetic field from passing through,
cooling means (4) that cool the superconductive solenoid (2) and the superconductive magnetic-field shield (5) to a temperature lower than a critical temperature T_{C}, for maintaining the superconductive properties of the superconductive solenoid (2) and the superconductive magnetic-field shield (5),
characterized in that it further comprises:
a core of a high magnetic permeability (3) having ends (α) and (β), wherein the superconductive solenoid (2) is wound at least in part around the high-magnetic-permeability core (3) so that a magnetic flux density B is generated throughout the high-magnetic-permeability core (3) from the one end (α) to the other end (β) with respective magnetic flux density vectors Bα and Bβ at the ends (α) and (β),
and in that the superconductive magnetic-field shield (5) covers the superconductive solenoid (2) and extends along the length of the high-magnetic-permeability core (3) from the one end (α) to the other end (β), wherein the high-magnetic-permeability core (3) includes one or more curved parts of any curvature so that when the superconductive solenoid (2) operates the Bα and Bβ vectors of the magnetic flux density tend to be perpendicular to the respective cross-sections of the ends (α) and (β), so that the alteration of the direction of the magnetic flux density B produced along each curved part generates force vectors Fα and Fβ at the respective ends (α) and (β) which act perpendicularly to the cross-sections of the ends (α) and (β) with direction outwards in respect to the high-magnetic-permeability core (3) and which generate a propulsive force F on the device (1) with direction and magnitude resulting from the sum of the force vectors Fα and Fβ.

2. Device (1) for generating propulsive force F according to claim 1, wherein the high-magnetic-permeability core (3) has a constant cross-section and is curved along its length.

3. Device (1) for generating propulsive force F according to claim 1, wherein the high-magnetic-permeability core (3) has a constant cross-section and includes an elongate part that ends to a curved part at each of its ends (α) and (β).

4. Device (1) for generating propulsive force F according to claim 3, wherein the curved part at the end (α) of the high-magnetic-permeability core (3) is configured to have a direction that is same with that of the curved part at the end (β) of the high-magnetic-permeability core (3).

5. Device (1) for generating propulsive force F according to claim 3, wherein the curved part at the end (α) of the high-magnetic-permeability core (3) is configured to have a direction that is opposite to that of the curved part at the end (β) of the high-magnetic-permeability core (3).

6. Device (1) for generating propulsive force F according to claim 1, wherein the superconductive solenoid (2) is a type II superconductor such as an activated tape or wire of the REBCO or YBCO or Bi2223 or NbTi type wound at least in part around the high-magnetic-permeability core (3).

7. Device (1) for generating propulsive force F according to claim 1, wherein the high-magnetic-permeability core (3) is a soft-iron core.

8. Device (1) for generating propulsive force F according to claim 1, wherein the cooling means (4) is a precooled copper wire positioned between the superconductive solenoid (2) and the superconductive magnetic-field shield (5) and wound around the superconductive solenoid (2).

9. Device (1) for generating propulsive force F according to claim 1, wherein the superconductive magnetic-field shield (5) includes along its length YBCO bulk and/or a Bi2223 magnetic shield cover and/or a REBCO tape winding.
